(19) United States
(12) Patent Application Publication
(10) Pub. No.: US 2012/0234510 A1
(43) Pub. Date: Sep. 20, 2012

(54) LANDSCAPE SHIELD APPARATUS AND METHOD

(75) Inventors: Ricky Mathew HILL, San Jose, CA (US); James Jeffrey KALINSKI, San Jose, CA (US)

(73) Assignee: LANDSCAPE SAFETY SYSTEMS, San Jose, CA (US)

(21) Appl. No.: 13/269,535

(22) Filed: Oct. 7, 2011

Related U.S. Application Data
(62) Division of application No. 13/049,884, filed on Mar. 16, 2011, now abandoned.

(51) Int. Cl. A47H 21/00; F16P 1/00

(52) U.S. Cl. 160/405

(57) ABSTRACT

A shield apparatus and method for using the apparatus are disclosed. The shield apparatus that includes first and second supports, a screen, and a retraction mechanism associated with the first support. The screen has opposing vertical edges attached to the supports. The retraction mechanism has a construction that allows the second support to be pulled toward the first support, e.g., by way of the screen. During use, the supports are positioned in a substantially vertical position at different locations.

### BACKGROUND OF THE INVENTION

Shields providing protection from flying debris or other moving objects have a variety of useful capabilities. For example, in the landscape/horticultural services area, power tools, such as mowers, rototillers, string trimmers and blowers may hurl objects such as debris into the air at speeds high enough to cause injury to individuals in the area, such as landscape/horticultural workers and/or bystanders and passersby, and to nearby property, such as cars and windows. It would therefore be useful to have protection from injuries caused by the hurled objects.

Shields that are portable also provide a variety of useful capabilities. For example, a portable shield may be easily placed in a specific area for a temporary period of time.

### SUMMARY OF THE INVENTION

A shield apparatus and methods for using such a shield are disclosed. The shield apparatus includes a screen which has a support attached to two of its edges. The lower end of each support is attached to a base which holds the support in a substantially vertical position. One of the supports includes a retraction mechanism that allows the other support to be pulled toward the first support, for example by way of the screen.

In some embodiments, the shield may be used to block debris hurled by a gardening device, such as a blower, rototiller, mower or string trimmer. A method is disclosed for using the shield in such a manner. The method includes identifying a grounds region for using a gardening device and transporting a shield apparatus to the region. The supports are positioned in a substantially vertical position at different locations and the screen is maintained in a substantially taut manner between the supports.

In some embodiments, the shield is portable.

### BRIEF DESCRIPTION OF THE DRAWINGS

FIG. 1A is a diagram illustrating an embodiment of the shield apparatus.

FIG. 1B is a diagram illustrating an embodiment of a housing for the shield apparatus.

FIG. 2A and FIG. 2B are diagrams illustrating an embodiment of the shield apparatus with a housing in cross-sectional view. FIG. 2A depicts the apparatus in a partially retracted configuration. FIG. 2B depicts the apparatus in an expanded configuration.

FIGS. 3A and 3B are diagrams illustrating embodiments of bases for the shield. FIG. 3A is a diagram illustrating an embodiment of one base for the shield apparatus and FIG. 3B is a diagram illustrating an embodiment of an alternative base for the shield apparatus.

FIG. 4 is a diagram illustrating an embodiment of an additional support for the shield apparatus.

### DETAILED DESCRIPTION OF THE INVENTION

While the invention is described in conjunction with the figures, the description and figures are provided to illustrate examples of the invention, and do not limit the scope of the invention. The figures are not necessarily drawn to scale, and certain dimensions may be exaggerated for clarity of presentation. Further, as used in this specification and the claims, the singular article forms “a,” “an,” and “the” include both singular and plural referents unless the context clearly dictates otherwise. Thus, for example, reference to “a support” includes more than one support as well as a single support, reference to “a base” includes a single base as well as more than one base, etc.

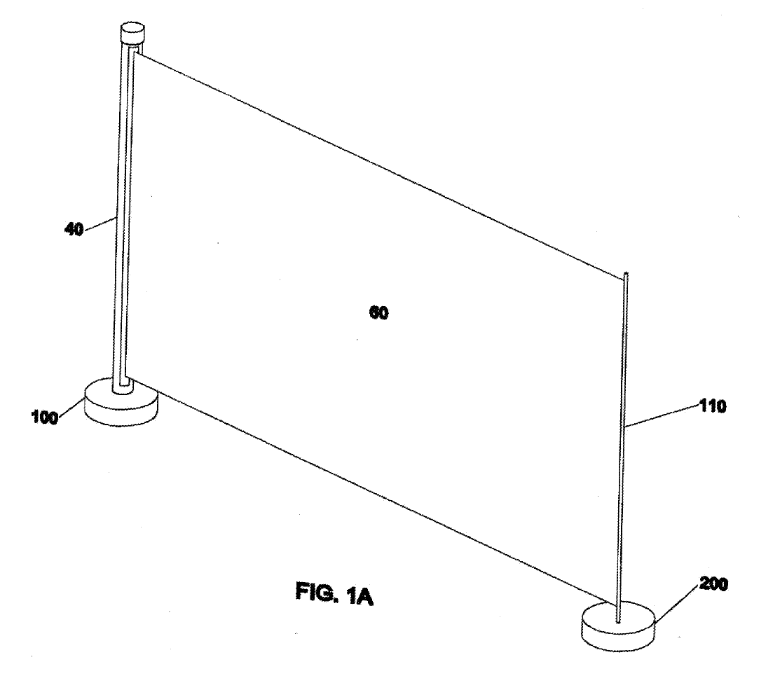

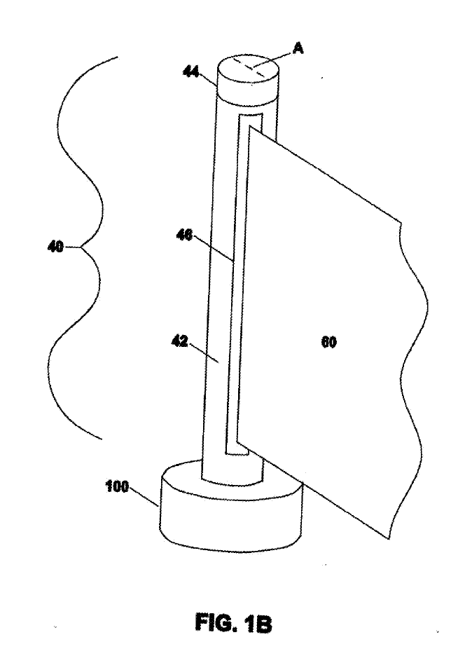

FIG. 1A is a diagram illustrating an embodiment of the shield apparatus. In the embodiment shown in FIG. 1A, the shield apparatus includes a screen 60, a support 110, a housing 40 and bases 100 and 200. FIG. 1B is a diagram illustrating the housing 40 in further detail. The housing 40 includes an end cap 44 and a hollow tube 42. The screen 60 traverses through an opening 46 of the hollow tube 42. The end cap 44 and tube 42 may be made from ordinary structural materials such as plastics, e.g., polyvinyl chloride (PVC), acrylonitrile-butadiene-styrene plastic (ABS), etc., fiberglass, metals, e.g., aluminum, rolled steel, or other appropriate materials.

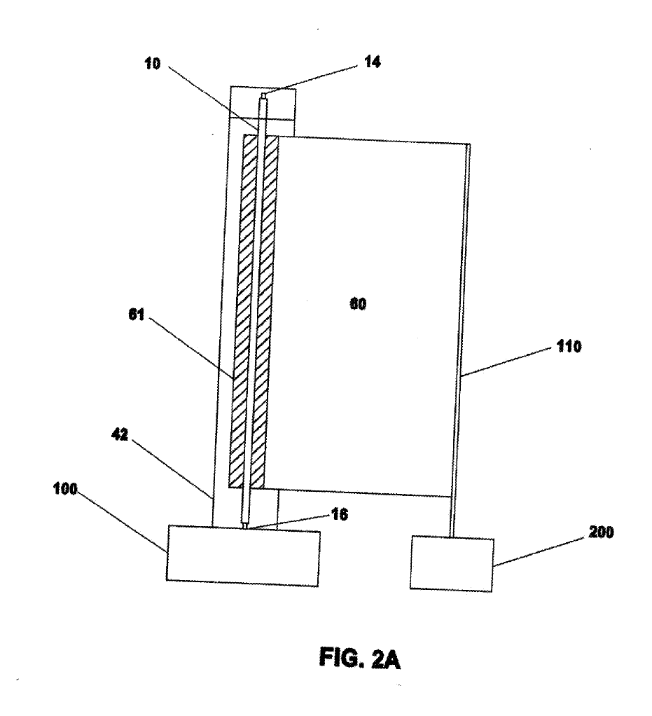

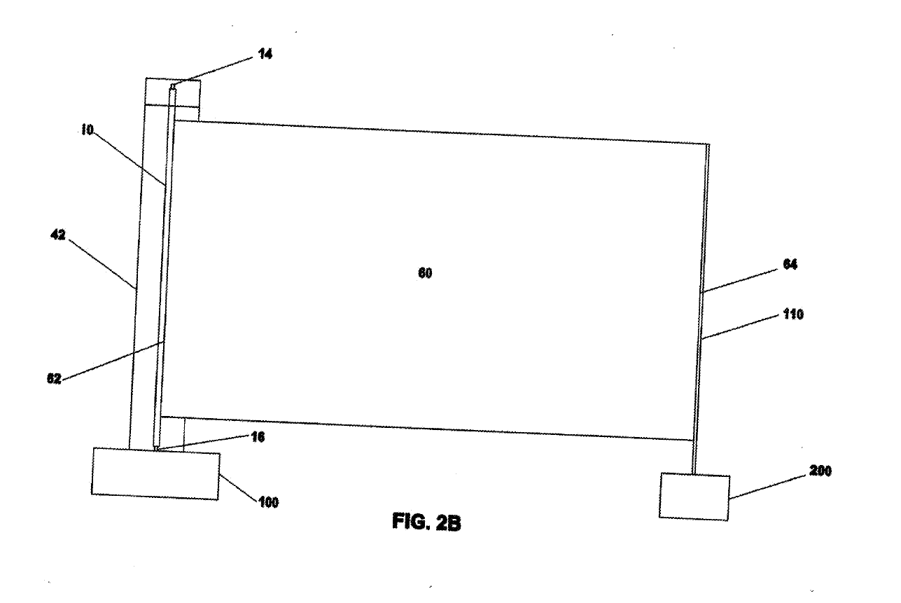

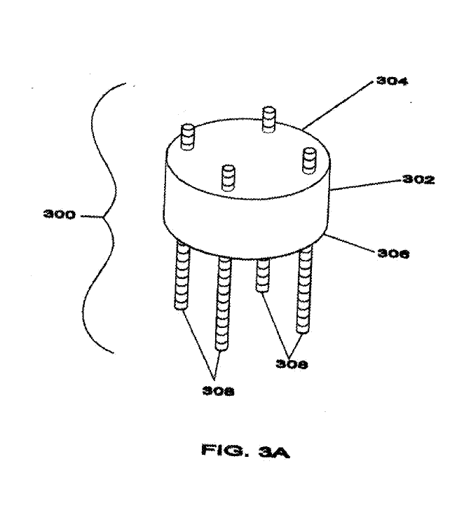

FIG. 2A and FIG. 2B are diagrams illustrating the housing 40 shown in FIG. 1B in cross sectional view along dotted A. FIG. 2A shows an example of a shield apparatus with the screen in a retracted configuration. FIG. 2B shows an example of a shield apparatus with the screen in an extended configuration.

As shown in FIGS. 2A and 2B, the shield apparatus includes an additional support 10 which may be located inside the housing. A cylindrical post may be used for the supports 10 and 110 as illustrated in FIGS. 2A and 2B, however, as would be well understood in the art, the support may comprise other shapes. A non-exclusive list of supports includes cylindrical wooden posts, telescoping poles, fiberglass poles, carbon fiber poles, etc. The supports 10 and 110 are comprised of a material that is strong enough to support the shield apparatus in a substantially vertical position when the screen is extended. A non-exclusive list of examples of materials for the supports 10 and 110 includes wood, aluminum or other metals, fiberglass, carbon fiber, and other appropriate materials. One of ordinary skill in art would be able to determine a proper shape and material for the support without undue experimentation.

“Substantially vertical position” is used in its ordinary sense to refer broadly to items that are more or less, but not necessarily precisely, aligned with the direction of the force of gravity, as materialized with a plumb line. The words “substantial” and “substantially” are used analogously in other contexts involving analogous definitions.

As shown in FIG. 2B, the screen 60 has opposing vertical edges 62 and 64. The term “vertical edge” is used in its ordinary sense to refer broadly to an edge, border, piping, hem, etc., located along the screens width as illustrated by 62 and 64. Support 10 is attached to vertical edge 62 and support 110 is attached to vertical edge 64. As used in this context “attached” is meant broadly and may refer to an indirect attachment as well as a direct attachment. As shown in FIG. 2, in some embodiments, the two supports 10 and 110 may have a length that is substantially equal. Some embodiments may, but need not, include a handle or other mechanism (not shown) attached to the support 110 to assist in extending the screen when the shield apparatus is in use.

FIGS. 2A and 2B also include an illustration of an example retraction mechanism for the shield apparatus. The retraction mechanism allows one of the supports to be pulled towards the other support, for example by way of the screen. In the embodiment shown in FIGS. 2A and 2B, support 10 includes an upper roller pin 14 and a lower roller pin 16. The upper roller pin 14 is attached to the end cap 44, and the lower roller pin is attached to the base 100. The upper and lower roller pins are attached such that the support 10 can rotate, while the hollow tube 42 (attached between the end cap 44 and the base 100) remains immobile.

In some embodiments, the retraction mechanism may also include a spring mechanism (not shown) similar to that found in pull-down projection screens or pull-down window blinds. In other embodiments, a built-in inertia reduction mechanism may be included. In operation, the screen 60 unrolls in a conventional manner when a user pulls support 110 away from support 10. Once the pulling action ceases, an automatic locking mechanism may be used to temporarily lock the screen in place. In such embodiments, an additional tug on the second support may deactivate the locking mechanism to allow the refraction mechanism to slowly and gently retract the screen to the closed position on its own via rotational motion.

In the embodiment illustrated in FIGS. 1A, 1B, 2A, and 2B, when the screen is extended, it has a generally rectangular shape. When the screen is retracted, the bulk of the screen 60 is wound against the support 10 such that the screen forms a roll 61 about the roller 10, as shown in FIG. 2A. As a result, the vertical edge is covered by layers of the screen when retracted. When the screen is extended as shown in FIG. 2B, the vertical edge 62 remains within the housing 40, but the screen 60 traverses through the housing opening 46 of FIG. 1B, and the bulk of the screen is positioned outside housing 40.

As would be understood by one of skill in the art, other retraction mechanisms may be used. For example, in some embodiments, the screen may be retracted via nonrotational motion, e.g., via folding action. Additionally, in some embodiments the screen may be manually rolled from one support to another.

In some embodiments, the shield apparatus may be easily disassembled and reassembled so that the parts can be easily replaced. For example, in some embodiments, the retraction mechanism may be constructed in a manner that allows for easily replacing damaged screens and the like. In some embodiments, the end cap 44 may be removable.

As shown in FIGS. 2A and 2B, the supports 10 and 110 are each associated with a base 100 and 200, respectively. In general, the bases are constructed to maintain the supports in a substantially vertical position during the use of the inventive apparatus.

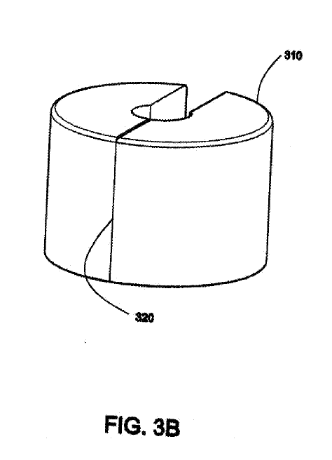

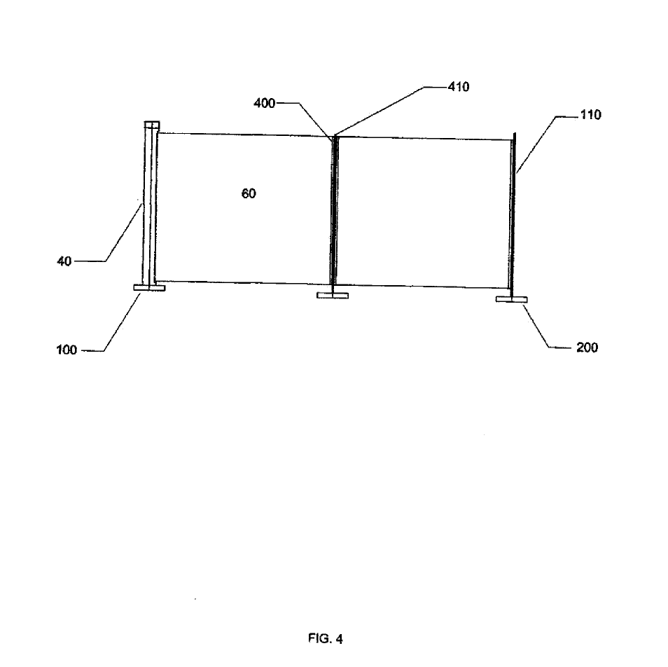

FIG. 3A is a diagram illustrating an example of a base that may be used in some embodiments. Base 300 is shown having a base plate 302 having upper and lower horizontal surfaces indicated by 304 and 306. Also provided is a plurality of stakes 308. In some embodiments, the stakes extend through and engage the base plate 302 via screw threads. In some such embodiments, by turning the stakes 308 relative to the base plate 302, the stakes' positions may be adjusted relative to the base plate 302. For example, the stakes' may be positioned such that the majority of their exposed length lies below surface 306. Alternatively, the stakes' position may be raised such that the majority of their exposed length lies above surface 304.

For embodiments using a base such as the one illustrated in FIG. 3A, the stakes may be driven into the ground so that screen stays in a substantially vertical position. For some embodiments, a user of the apparatus shield may step on the horizontal surface of the base to drive the stakes associated therewith into the ground. Alternatively, hammers and other tools may be used to drive the stake downward. For such embodiments, the bases should be made from materials that can withstand the forces associated with their use. For example, if hammers are to be used to drive the stakes of the bases into the ground, the stakes should be made of a sufficiently strong material, e.g., steel, to withstand the forces resulting from impact with hammers. If the length of the stakes is adjustable, changing the length of the stakes so that less is below the base 302 may allow the base to be driven into the ground more easily. Changing the length of the stakes so that more is below the base may provide more stability to the supports.

FIG. 3B is a diagram illustrating an alternative embodiment of a base. The base illustrated in FIG. 3B includes a fillable compartment that may be filled, e.g., with substances such as water, rocks, sand, and/or soil. As illustrated, the fillable base comprises hollow compartments 310 each having an opening through which substances for weighting down the base may be introduced. In some embodiments, the compartments may be joined by a hinge 320. The hinge allows the compartments 310 to swing open and closed around the lower end of supports of the inventive apparatus. Once filled, the base should possess sufficient weight to render any support attached thereto upright when the base is placed on a hard surface.

The bases 100 and 200 may be affixed to, restrained with, or otherwise attached to the supports 10 and 110. In some embodiments, the base may include an integrated support socket (not shown) which may be used to mobilize the lower end of supports 10 and 100. In some embodiments, base and support attachment may be made permanent. Alternatively, the bases and supports may be made detachable from each other. Base and support attachment may be made directly or indirectly. For example, in the embodiments illustrated in FIGS. 1A, 1B, 2A and 2B, support 110 may be attached to the base 200 directly, for example by inserting and affixing the support's lower end directly in a support socket in the base (not shown), and support 10 may be attached to base 100 indirectly, via a housing.

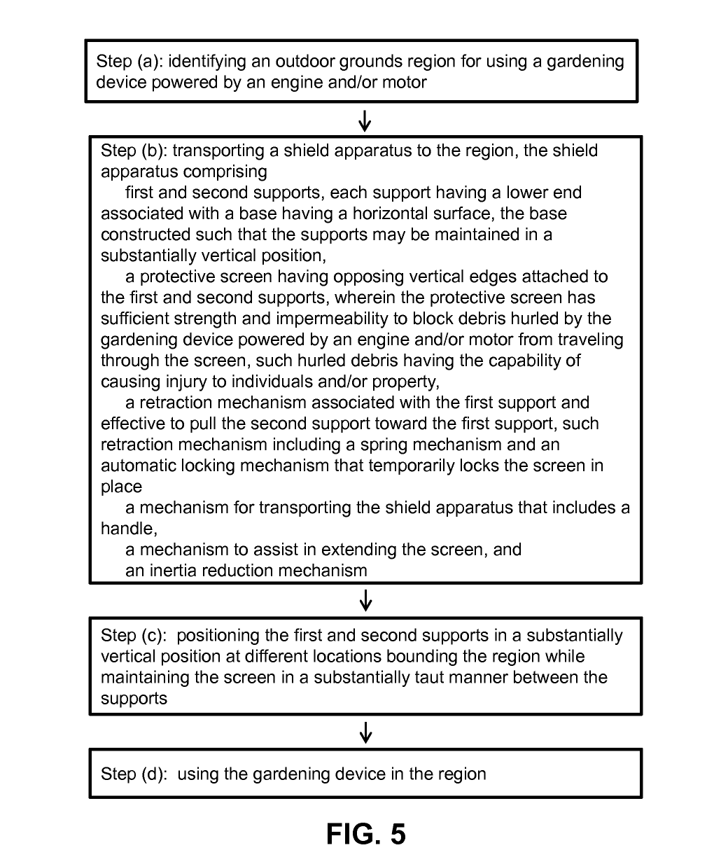

In some embodiments, additional supports and bases may be physically associated with a portion of the screen located between the supports attached to the vertical edges. The additional supports may be attached to the screen in any of a number of ways. For example, at the place for attaching the additional supports, the screen may include loops, casings, piping, hems or other appropriate means for attaching the supports. In some embodiments, supports may be placed approximately 20 feet apart or less, i.e. there will be about 20 feet or less distance between any two supports. FIG. 4 is a diagram illustrating an embodiment of the shield apparatus in FIG. 1 with an additional support 410. In the embodiment illustrated in FIG. 4, the extra support 410 is attached to the screen with a casing as illustrated at 400. In some embodiments, the supports may be evenly spaced. In some embodiments, supports may be placed more than 20 feet apart, depending in part on the materials used for the screen and the supports. One of ordinary skill in art would be able to determine without undue experimentation the proper placing of the distance between the supports so that the screen may be maintained substantially taut and in a substantially vertical position.

In some embodiments, the shield apparatus may be constructed so that it is portable. “Portable” is used in its ordinary sense to refer broadly to items that may be transported in a relatively easy manner. In such embodiments, a housing may be included, such as the housing illustrated at 40 of FIG. 1. In some such embodiments, the housing may include a handle. In embodiments that are portable, the weight of materials will be a factor for choosing the materials for constructing the shield apparatus. For example, in some embodiments, the screen may be constructed of a fairly light material. In some portable embodiments, the weight of the shield apparatus may be around 20 pounds or less. For example, in some embodiments, the shield apparatus may weigh between 5 and 15 pounds. In some portable embodiments, the shield may be heavier than 20 pounds based in part on the length and width of the screen.

The shield apparatus is useful in numerous industries. A non-exclusive list of industries in which the shield apparatus would be useful includes, landscaping/horticulture, construction, industries in which debris may be generated and/or hurled by motorized equipment, and other industries with the need for a shield. The term “debris” is used herein in its ordinary sense and refers to small pieces or fragments of something, e.g., pebbles, and small rocks, rubble, or small pieces of improperly discarded items found on grounds regions where work such as landscaping activities may occur. Exemplary debris that may be generated and/or hurled during the use of landscaping and/or gardening equipment include, for example, pebbles, masonry pieces, glass fragments, sand, nails, etc. The term “hurl” is used herein in its ordinary sense and refers to propelling, throwing, launching, bouncing, etc., into the air by any means.

The shield apparatus is useful in numerous places. A non-exclusive list of examples of places where the shield apparatus is useful includes places where landscape maintenance is being conducted, e.g., schools, apartment complexes, business parks, etc.

In some embodiments, the shield apparatus is used in the landscaping/horticulture industry to block debris hurled by gardening tools, such as mowers, blowers, rototillers, and string trimmers. In some such embodiments, the shield apparatus may be constructed and used to block debris hurled by a string trimmer. The term “string trimmer” is used herein in its ordinary sense to broadly describe a powered handheld device that uses a “string,” such as a flexible monofilament line, instead of a blade for cutting grass and other plants near objects. String trimmers typically include a cutting head at the end of a long shaft with a handle or handles. In use, the head of string trimmers spins the string at a high rate of speed to cut plant matter. Some string trimmers are used to cut quite large woody plants such as small shrubs.

Because the head of a string trimmer spins at a high rate of speed, objects such as debris may be hurled at extremely high velocities and or with great force, thereby causing damage to people, cars and or buildings, etc. While the user of a string trimmer may use standard protective gear for use with power tools such as safety glasses, goggles, a face shield gloves, and lower leg guards, these will not protect other people in the area such bystanders or passersby, nor the property in the area. Additionally, some string trimmers may include attached guards or shields on the string trimmer device itself. However, these guards or shields do not block all debris arising from the operation of trimmers. Thus, debris may still be hurled and injure other people in the area and property.

In embodiments in which the shield apparatus is used with a string trimmer, the shield apparatus may be transported to a grounds region where a device prone to hurl flying debris may be used. The supports are positioned in a substantially vertical position at different locations in the region, while the screen is maintained in a substantially taut manner between the supports. The screen may serve to block debris hurled during use of the device in the region. Once work is completed, the retraction mechanism may be activated to retract the support attached to one vertical edge of the screen to the opposing vertical edge.

Depending on the intended use of the apparatus shield, the construction of the screen used in the apparatus shield, such as the screen's dimensions, strength, and composition, may vary. The height of the screen may also vary depending on its use. For example, in some embodiments, when the invention is used to protect bystanders, the screen may have a height greater than that of the bystanders. For example, in some embodiments used to protect children, a screen having a height of about 4 feet may be used. In other embodiments also used to protect adults, a screen having a height of up to about 7 feet may be adequate to protect most adult bystanders. For embodiments that are portable, an excessive height may be undesirable. These dimensions are exemplary and are not meant to be limiting. One of skill in the art would be able to assess the proper height for the particular use of the shield apparatus without undue experimentation.

The length of the screen may also vary according to the intended use of the shield apparatus. For example, for some embodiments the screen should have a sufficiently long length so that the user does not have to move the screen often during use. For example, in some embodiments depending on the use, the screen may have a length of at least about ten to twenty feet or more when completely extended. In some embodiments, one more additional supports and bases may be required because of the length of the screen and the material of the screen. These dimensions are exemplary and are not meant to be limiting. One of skill in the art would be able to assess the proper length for the particular use of the shield apparatus without undue experimentation.

Any of a number of commercially available materials may be used as long as the material can be made sufficiently strong for the apparatus's intended use. For example, polymeric materials such as nylon and polyester may be found in mesh form. Similarly, materials used in windows for insect screening such as aluminum and fiberglass may be used as well. Less common mesh materials that may be used include bronze, copper, brass, stainless steel, and galvanized steel. Naturally occurring cloth fabrics, e.g., cotton and burlap, and synthetic films such as polyethylene and polypropylene may be used as well.

For landscaping/horticulture applications, the shield should have a construction (i.e. enough strength and dimension) that allows the screen, when rendered taut between the supports, to block debris hurled by a gardening device e.g., tools with an electrical motor and/or a gas-powered engine. Exemplary power gardening tools known to generate debris include, for example, string trimmers, leaf blowers, mowers, rototillers, etc.

Through routine experimentation in view of the manufacturer's specification for such tool, persons of ordinary skill in the art would be able to determine a suitable screen without undue experimentation. For example, commercial gas-powered string trimmers have 1.6 horse-power two-stroke engine with a 33.6 cubic centimeter displacement. Nylon mesh may be successfully used in the context of the inventive apparatus to prevent debris generated by the spinning head of such string trimmers. Another material that may be used for the screen in a shield apparatus, which is used to block debris such as that hurled by a string trimmer, is a charcoal fiberglass mesh screen, such as the one sold by Phifer, Inc. Another material that may be used for a screen in a shield apparatus that is may be used with a string trimmer is a vinyl-coated polyester screen, such as the SunTex® 80 screen with a breaking strength of 400 warp or SunTex® 90 screen with a breaking strength of 480 warp sold by Phifer, Inc. These examples are provided as illustrations of example materials and are not meant to be limiting. One of skill in the art would be able to assess a proper material for the screen without undue experimentation.

Depending on the intended use of the inventive apparatus, the screen may vary in permeability. Typically, a wind permeable material may be desired for outdoor use, as it may be difficult to maintain a wind-impermeable screen in a taut vertical orientation between the supports when the weather does not permit. However, mesh sizes should not be so excessive such that the ability of the screen to block debris is compromised. Upon routine experimentation, persons of ordinary skill in the art would be able to select a screen material with appropriate wind and/or debris permeability.

Similarly, the screen may vary in appearance depending on aesthetic and/or functional consideration. For example, the screen may be colored green, a color associated with landscaping. In addition, the screen may also serve to warn bystanders from approaching the grounds regions where work may take place. Such warnings may be communicated via printed text, symbols, and/or colors ordinarily associated with caution and/or safety, e.g., yellow or orange or black, etc. Optionally, the screen may be see-through, opaque, or anything in between.

Variations of the present invention will be apparent to those of ordinary skill in the art in view of the disclosure contained herein. For example, the invention is not limited to the area of landscaping/horticulture. In addition, the inventive apparatus may be constructed to contain or exclude specific features and components according to the intended use of the apparatus, and any particular embodiment of the invention, e.g., those depicted in any drawing herein, may be modified to include or exclude element of other embodiments. Alternatively, stated, different features of the invention described above may be combined in different ways.

While the invention has been described in conjunction with the preferred specific embodiments thereof, the foregoing description merely illustrates and does not limit the scope of the invention. Numerous alternatives and equivalents exist which do not depart from the invention set forth above. Other aspects, advantages, and modifications within the scope of the invention will be apparent to those skilled in the art to which the invention pertains.

1-23. (canceled)

24. A method of using a shield apparatus, comprising:
(a) identifying an outdoor grounds region for using a gardening device powered by an engine and/or motor;
(b) transporting a shield apparatus to the region, the shield apparatus comprising
first and second supports, each support having a lower end associated with a base having a horizontal surface, the base constructed such that the supports may be maintained in a substantially vertical position,
a protective screen having opposing vertical edges attached to the first and second supports, wherein the protective screen has sufficient strength and impermeability to block debris hurled by the gardening device powered by an engine and/or motor from traveling through the screen, such hurled debris having the capability of causing injury to individuals and/or property, and
a retraction mechanism associated with the first support and effective to pull the second support toward the first support, such retraction mechanism including a spring mechanism and an automatic locking mechanism that temporarily locks the screen in place;
(c) positioning the first and second supports in a substantially vertical position at different locations bounding the region while maintaining the screen in a substantially taut manner between the supports; and
(d) using the gardening device in the region.

25. (canceled)

26. The method of claim 24, wherein at least one base is detachable from a support.

27. The method of claim 24, wherein at least one base includes a plurality of attached stakes extending downward relative to the horizontal base surface.

28. The method of claim 27, wherein the positions of the stakes are adjustable relative to the horizontal base surface.

29. The method of claim 24, wherein at least one base includes a fillable compartment.

30. The method of claim 29, wherein the compartment is waterfillable.

31. The method of claim 29, wherein the compartment may be filled with a substance selected from rocks, sand, and/or soil.

32. The method of claim 24, wherein the protective screen has a height of about 4 feet to about 7 feet.

33. The method of claim 24, wherein the protective screen comprises a polymeric material.

34. The method of claim 24, wherein the protective screen is wind permeable.

35. The method of claim 24, wherein the device is a handheld device.

36. The method of claim 35, wherein the device is a trimmer or blower.

37. The method of claim 35, wherein the device is a string trimmer.

38. The method of claim 24, wherein at least one additional support is physically associated with a portion of the protective screen located between the opposing vertical edges.

39. The method of claim 24, wherein no support is located at a distance greater than about 20 feet from at least one other support.

40. The method of claim 24, wherein the retraction mechanism retracts the protective screen by way of rotational motion.

41. The method of claim 24, wherein the retraction mechanism is constructed such that the protective screen is replaceable.

42. The method of claim 24, wherein the shield apparatus further comprises a housing associated with the first support, which is constructed such that the apparatus is portable and includes a mechanism for transporting the shield apparatus.

43. The method of claim 42, wherein the mechanism for transporting the shield apparatus includes a handle.

44. (canceled)

45. (canceled)

46. The method of claim 24, wherein the shield apparatus has a total weight not exceeding about 20 pounds.

47. The method of claim 24, wherein the second support is associated with a mechanism to assist in extending the screen when the shield apparatus is in use.

48. The method of claim 47 wherein the mechanism to assist in extending the screen is a handle.

49. The method of claim 41, wherein the housing includes an end cap that is removable.

50. The method of claim 24, wherein the locking mechanism is capable of being deactivated by a tug on the second support.

51. The method of claim 24, wherein the retraction mechanism includes a built-in inertia reduction mechanism.
